(19) United States
(12) Patent Application Publication
(10) Pub. No.: US 2026/0238881 A1
(43) Pub. Date: Aug. 13, 2026

(54) SYSTEMS AND METHODS FOR ADAPTIVE SPLIT IMAGING

(71) Applicant: QUALCOMM Incorporated, San Diego, CA (US)

(72) Inventors: Manmohan MANOHARAN, Bengaluru (IN); Wesley James HOLLAND, Encinitas, CA (US); Kapil AHUJA, Bengaluru (IN); Pawan Kumar BAHETI, San Diego, CA (US); Hao MENG, San Diego, CA (US); Naveen SRINIVASAMURTHY, Bangalore (IN); Ajit Deepak GUPTE, Bangalore (IN); Chirag Maheshkumar PUJARA, Bangalore (IN); Simon Peter William BOOTH, San Diego, CA (US); Animesh BEHERA, Bengaluru (IN)

(21) Appl. No.: 19/160,015

(22) PCT Filed: Dec. 5, 2023
(86) PCT No.: PCT/US2023/082586

§ 371 Date: Aug. 26, 2025

(30) Foreign Application Priority Data
May 1, 2023 (IN) 202341030966

(51) Int. Cl. H04N 23/65; G06T 3/4046; G06T 3/4053; G06T 5/60; G06T 5/70; H04N 23/52; H04N 23/68; H04N 23/71; H04N 23/90

(52) U.S. Cl. CPC H04N 23/651; G06T 3/4046; G06T 3/4053; G06T 5/60; G06T 5/70; H04N 23/52; H04N 23/6811; H04N 23/71; H04N 23/90; G06T 2207/20081; G06T 2207/20084

(57) ABSTRACT

Imaging systems and techniques are described. In some examples, an imaging system monitors a characteristic of power usage of the apparatus. The system selects, based on at least the characteristic of power usage of the apparatus, an imaging scheme from a plurality of imaging schemes. Each of the plurality of imaging schemes represents a different division of image processing operations between the at least one processor and a companion device. The system sends image data to the companion device for processing the image data using at least one image processing operation to generate processed image data according to the imaging scheme. In some examples, the at least one image processing operation includes a denoising operation. The system receives the processed image data from the companion device.

### FIELD

The present disclosure generally relates to image capture and processing. For example, aspects of the present disclosure relate to systems and techniques for splitting up image processing operations for an image between a first device and a second device to reduce power usage and/or heat generation at the first device, with different image processing schemes selected for different scenarios and providing different breakdowns of which device performs which image processing operations.

### BACKGROUND

Many devices include one or more cameras. For example, a smartphone or tablet includes a front facing camera to capture selfie images and a rear facing camera to capture an image of a scene (such as a landscape or other scenes of interest to a device user). A camera can capture images using an image sensor of the camera, which can include an array of photodetectors. Some devices can analyze image data captured by an image sensor to detect an object within the image data. Sometimes, cameras can be used to capture images of scenes that include one or more people.

### BRIEF SUMMARY

Systems and techniques for imaging are described. In some examples, an imaging system monitors a characteristic of power usage of the apparatus. The system selects, based on at least the characteristic of power usage of the apparatus, an imaging scheme from a plurality of imaging schemes. Each of the plurality of imaging schemes represents a different division of image processing operations between the at least one processor and a companion device. The system sends image data to the companion device for processing the image data using at least one image processing operation to generate processed image data according to the imaging scheme. In some examples, the at least one image processing operation includes a denoising operation. The system receives the processed image data from the companion device.

According to at least one example, an apparatus for imaging is provided. The apparatus includes a memory and at least one processor (e.g., implemented in circuitry) coupled to the memory. The at least one processor is configured to and can: select, based on at least a characteristic of power usage of the apparatus, an imaging scheme from a plurality of imaging schemes, wherein each of the plurality of imaging schemes represents a different division of image processing operations between the at least one processor and a companion device; send image data to the companion device for processing the image data using at least one image processing operation to generate processed image data according to the imaging scheme, wherein the at least one image processing operation includes a denoising operation; and receive the processed image data from the companion device

In another example, a method of imaging is provided. The method includes: selecting, based on at least a characteristic of power usage of the apparatus, an imaging scheme from a plurality of imaging schemes, wherein each of the plurality of imaging schemes represents a different division of image processing operations between the at least one processor and a companion device; sending image data to the companion device for processing the image data using at least one image processing operation to generate processed image data according to the imaging scheme, wherein the at least one image processing operation includes a denoising operation; and receiving the processed image data from the companion device %

In another example, a non-transitory computer-readable medium is provided that has stored thereon instructions that, when executed by one or more processors, cause the one or more processors to: select, based on at least a characteristic of power usage of the apparatus, an imaging scheme from a plurality of imaging schemes, wherein each of the plurality of imaging schemes represents a different division of image processing operations between the at least one processor and a companion device; send image data to the companion device for processing the image data using at least one image processing operation to generate processed image data according to the imaging scheme, wherein the at least one image processing operation includes a denoising operation; and receive the processed image data from the companion device

In another example, an apparatus for imaging is provided. The apparatus includes: means for selecting, based on at least a characteristic of power usage of the apparatus, an imaging scheme from a plurality of imaging schemes, wherein each of the plurality of imaging schemes represents a different division of image processing operations between the at least one processor and a companion device; means for sending image data to the companion device for processing the image data using at least one image processing operation to generate processed image data according to the imaging scheme, wherein the at least one image processing operation includes a denoising operation; and means for receiving the processed image data from the companion device

In some aspects, the apparatus is part of, and/or includes a wearable device, an extended reality device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating an example architecture of an image capture and processing system, in accordance with some examples;

FIG. 2 is a flow diagram illustrating a process for selecting an image processing scheme, in accordance with some examples;

FIG. 3 is a flow diagram illustrating a first image processing scheme with some image processing operations performed using a display device (e.g., headset) and some image storage operations performed using a host device, in accordance with some examples;

FIG. 4 is a flow diagram illustrating a second image processing scheme with some image processing operations performed using a display device (e.g., headset) and some image processing operations (including stabilization) performed using a host device, in accordance with some examples;

FIG. 5 is a flow diagram illustrating a third image processing scheme with some image processing operations performed using a display device (e.g., headset) and some image processing operations (including stabilization and temporal denoising) performed using a host device, in accordance with some examples;

FIG. 6 is a flow diagram illustrating a fourth image processing scheme with some image processing operations performed using a display device (e.g., headset) and some image processing operations (including stabilization, temporal denoising, and spatial denoising) performed using a host device, in accordance with some examples;

FIG. 7A is a perspective diagram illustrating a head-mounted display (HMD) that is used as part of an imaging system, in accordance with some examples;

FIG. 7B is a perspective diagram illustrating the head-mounted display (HMD) of FIG. 7A being worn by a user, in accordance with some examples;

FIG. 8A is a perspective diagram illustrating a front surface of a mobile handset that includes front-facing cameras and that can be used as part of an imaging system, in accordance with some examples;

FIG. 8B is a perspective diagram illustrating a rear surface of a mobile handset that includes rear-facing cameras and that can be used as part of an imaging system, in accordance with some examples;

FIG. 9 is a perspective diagram illustrating a vehicle that includes various sensors, in accordance with some examples;

FIG. 10 is a block diagram illustrating an example of a neural network that can be used for imaging, in accordance with some examples;

FIG. 11 is a flow diagram illustrating a process for imaging, in accordance with some examples; and

FIG. 12 is a diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

Imaging systems and techniques are described. In some examples, an imaging system monitors a characteristic of power usage of the apparatus. The system selects, based on at least the characteristic of power usage of the apparatus, an imaging scheme from a plurality of imaging schemes. Each of the plurality of imaging schemes represents a different division of image processing operations between the at least one processor and a companion device. The system sends image data to the companion device for processing the image data using at least one image processing operation to generate processed image data according to the imaging scheme. In some examples, the at least one image processing operation includes a denoising operation. The system receives the processed image data from the companion device.

The imaging and feature tracking systems and techniques described herein provide a number of technical improvements over prior imaging and feature tracking systems. For instance, the imaging and feature tracking systems and techniques described herein can reduce power usage and heat generation by a headset or other device by offloading certain image processing operations onto another device (a host device) that is less battery-constrained and/or temperature-constrained. For instance, headsets are generally built to be even smaller and lighter than handsets because headsets are built to be worn on a user's face and/or head for long periods of time, and need to be comfortable to users wearing them in this manner. Because of this, headsets have even less capacity (both in terms of physical space and weight) for large batteries than handsets, and instead generally have smaller batteries than handsets. Furthermore, because headsets are built to be worn on a user's face and/or head for long periods of time, headsets are even more temperature-sensitive than handsets, as a user's face and eyes are generally even more sensitive to heat (and/or damage from high heat) than a user's hands or pockets. By pushing certain image processing operations described as performed by the imaging system from the headset to the handset as discussed with respect to some of the image processing schemes discussed herein, the headset is able to use less battery power, last longer, maintain a lower (and thus safer) heat by generating less heat, and require less thermal dissipation hardware (e.g., fans or other cooling systems) or thermal throttling (e.g., which can result in undesirable performance drops) as a result.

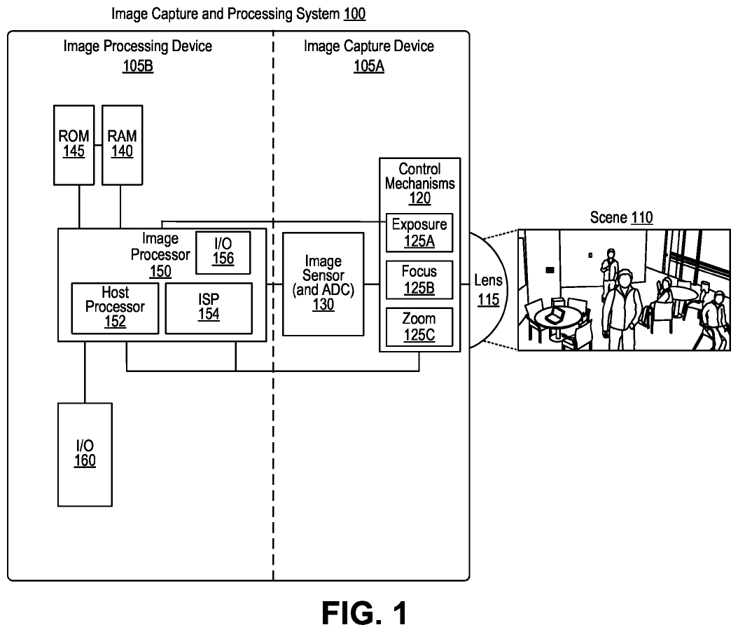

Various aspects of the application will be described with respect to the figures. FIG. 1 is a block diagram illustrating an architecture of an image capture and processing system 100. The image capture and processing system 100 includes various components that are used to capture and process images of one or more scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130. In some examples, the scene 110 is a scene in an environment. In some examples, the image capture and processing system 100 is coupled to, and/or part of, a vehicle 190, and the scene 110 is a scene in an environment around the vehicle 190. In some examples, the scene 110 is a scene of at least a portion of a user. For instance, the scene 110 can be a scene of one or both of the user's eyes, and/or at least a portion of the user's face.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting. In some examples, an exposure setting can be provided to the exposure control mechanism 125A of the control mechanisms 120 from the image processor 150, the host processor 152, the ISP 154, or a combination thereof.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1210 discussed with respect to the computing system 1200. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (13C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HIDR image, image recognition, object recognition, feature recognition, receipt of inputs, managing outputs, managing memory, or some combination thereof. The image processor 150 may store image frames and/or processed images in random access memory (RAM) 140 and/or 1220, read-only memory (ROM) 145 and/or 1225, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1235, any other input devices 1245, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the system 100 and one or more peripheral devices, over which the system 100 may receive data from the one or more peripheral device and/or transmit data to the one or more peripheral devices. The I/O 160 may include one or more wireless transceivers that enable a wireless connection between the system 100 and one or more peripheral devices, over which the system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 1202.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

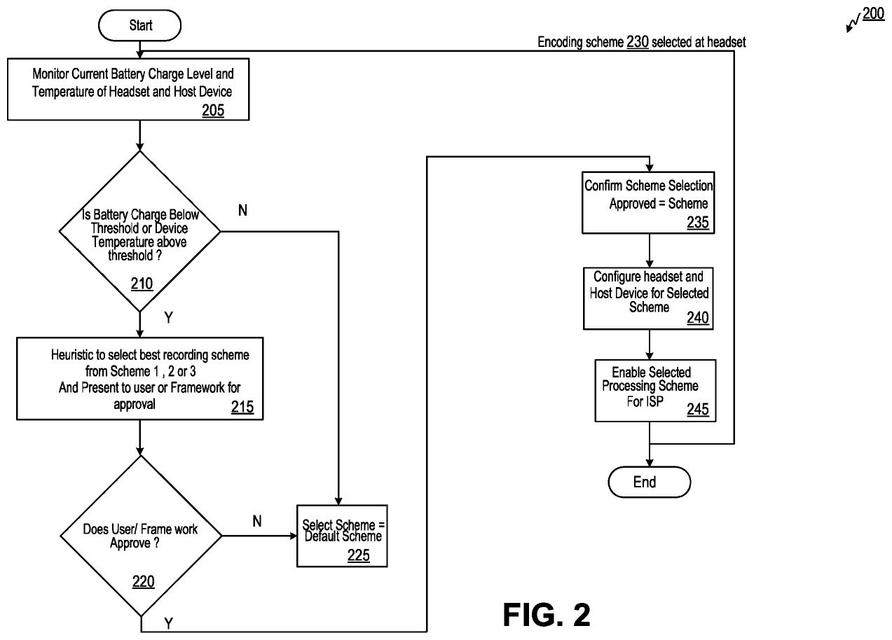

FIG. 2 is a flow diagram illustrating a process 200 for selecting an image processing scheme. An imaging system performs the process 200. The imaging system can include the image capture and processing system 100, the image capture device 105A, and/or the image processing device 105B. The imaging system includes a headset and a host device. The headset can be an example of the display device 305 (e.g., headset) and/or the head-mounted display (HMD) 710. In some examples, the headset can instead be a handset such as the mobile handset 810 or a vehicle such as the vehicle 910. The headset can further be an example of a computing system 1200. The host device can be a device that is communicatively coupled to the headset via an interface (e.g., wired and/or wireless), and can be referred to as a companion device to the headset. In some examples, the headset can be referred to as a companion device of the host device. The host device can be an example of the host device 310, the HMD 710, the mobile handset 810, the vehicle 910, and/or the computing system 1200.

During the process 200, the imaging system (e.g., the headset, the host device, or both) can select an image processing scheme from multiple possible image processing schemes. Image processing can include a number of operations, such as stabilization, temporal denoising, spatial denoising, super-resolution, and the like. The different possible image processing schemes can divide operations for image processing, such as the previously-listed operations, differently between the headset and the host device. In some image processing schemes, the headset performs more of the image processing operations, while in other image processing schemes, the host device performs more of the image processing operations. Examples of the different possible image processing schemes include the first image processing scheme 300, the second image processing scheme 400, the third image processing scheme 500, the fourth image processing scheme 600, and any other image processing schemes discussed herein. Which image processing scheme is selected can be based on comparison of a monitored value (e.g., battery charge level, temperature, another metric, a heuristic based on one or more metrics, or a combination thereof) against a threshold.

By spreading the image processing operations across two or more devices as discussed in some of the image processing schemes, technical benefits can be realized. For instance, headsets (such as the display device 305 or the HMD 710) are generally built to be even smaller and lighter than handsets (such as the host device 310 or the mobile handset 810) because headsets are built to be worn on a user's face and/or head for long periods of time, and need to be comfortable to users wearing them in this manner. Because of this, headsets have even less capacity (both in terms of physical space and weight) for large batteries than handsets, and instead generally have smaller batteries than handsets. Furthermore, because headsets are built to be worn on a user's face and/or head for long periods of time, headsets are even more temperature-sensitive than handsets, as a user's face and eyes are generally even more sensitive to heat (and/or damage from high heat) than a user's hands or pockets. By pushing certain image processing operations described as performed by the imaging system from the headset to the handset as discussed with respect to some of the image processing schemes discussed herein, the headset is able to use less battery power, last longer, maintain a lower (and thus safer) heat by generating less heat, and require less thermal dissipation hardware (e.g., fans or other cooling systems) or thermal throttling (e.g., which can result in undesirable performance drops) as a result.

The process 200 can begin with operation 205. At operation 205, the imaging system (or a subsystem thereof) monitors a current battery charge level and/or temperature of the headset and/or of the host device. At operation 210, the imaging system determines whether the battery charge level for the monitored device (e.g., the headset and/or the host device) is below a battery charge level threshold and/or whether the temperature of the monitored device (e.g., the headset and/or the host device) is above a temperature threshold. If the monitored battery charge level exceeds the battery charge level threshold and the monitored temperature is below the temperature threshold, then at operation 225, the imaging system can select a default scheme from the different possible image processing schemes. The default scheme can be, for instance, any of the first image processing scheme 300, the second image processing scheme 400, the third image processing scheme 500, or the fourth image processing scheme 600. In an illustrative example, the first image processing scheme 300 is the default scheme.

If the monitored battery charge level falls below the battery charge level threshold and/or the monitored temperature is at least at the temperature threshold, then at operation 215, the imaging system can calculate a heuristic and compare the heuristic to one or more thresholds to determine which image processing scheme to select. In some examples, the heuristic can be based on at least the monitored battery charge level and/or the monitored temperature. For instance, if the monitored battery charge level is determined at operation 215 to be still relatively high, and/or if the monitored temperature is determined at operation 215 to be still relatively low, then the second image processing scheme 400 can be selected. If the monitored battery charge level is determined at operation 215 to be at a medium level, and/or if the monitored temperature is determined at operation 215 to be at a medium level, then the third image processing scheme 500 can be selected. If the monitored battery charge level is determined at operation 215 to be very low, and/or if the monitored temperature is determined at operation 215 to be very high, then the fourth image processing scheme 600 can be selected.

At operation 220, the imaging system can request approval to use the selected image processing scheme from the user (e.g., via a user interface), from a framework that automatically approves or rejects based on rules, or both. If the user and/or the framework reject the selected image processing scheme, then the default image processing scheme can be selected instead at operation 225. If the user and/or the framework approve the selected image processing scheme, then selection of the selected image processing scheme is confirmed at operation 235. At operation 240, the imaging system configures the headset and the host device for the selected image processing scheme, for example by sending sets of instructions and/or commands for implementing the selected image processing scheme to the headset and to the host device, respectively. At operation 245, the imaging system enables the newly selected image processing scheme for the headset and host device, in some cases using image signal processors (ISPs) of the headset and the host device, respectively, and in some cases splitting ISP operations among the headset and the host device. In some examples, an encoding scheme 230 is selected at the headset for the selected image processing scheme based on how much data is to be sent between the headset and the handset. The encoding scheme 230 can be an input to future instances of the monitoring of operation 205, as the encoding scheme 230 can affect how much power is being drawn by the headset, and thus how much heat is being generated by the headset.

In some examples, the heuristic of operation 215 can also be based on other metrics and/or parameters instead of or in addition to the monitored battery charge level and/or the monitored temperature. For instance, in some examples, the heuristic can be based on estimated power consumption of an image processing operation to be performed and/or estimated heat to be generated by the image processing operation to be performed. In some examples, the heuristic can be based on an estimate of how much battery life is remaining in the monitored device (e.g., the headset and/or the host device), how far away (e.g., in degrees Celsius, degrees Fahrenheit, degrees Kelvin, or another temperature metric) the monitored temperature of the monitored device is from a maximum skin-safe temperature threshold, and/or how long it would take for the monitored device to reach the maximum skin-safe temperature threshold. For instance, if an operation is not expected to produce a major decrease in battery charge or a major increase in temperature, the imaging system can select an image processing that does more image processing operations on the headset and fewer image processing operations on the host device, like the first image processing scheme 300 or the second image processing scheme 400. On the other hand, if an operation is expected to produce a major decrease in battery charge or a major increase in temperature, the imaging system can select an image processing that does fewer image processing operations on the headset and more image processing operations on the host device, like the third image processing scheme 500 or the fourth image processing scheme 600. For instance, operations such as stabilization generally use significant power and generate significant heat, and may thus be best to offload to the host device (e.g., as in the second image processing scheme 400, the third image processing scheme 500, and the fourth image processing scheme 600).

In some examples, offloading certain tasks to the host device can slightly decrease image quality in the result, since the headset may compress the image data (and potentially introduce compression artifacts) before sending the image data to the host device for processing. The earlier in the image processing process the image data is sent to the host device (and the more image processing operations are done on the host device), the more these compression artifacts may be propagated throughout the image processing process, in a way that may make the compression artifacts difficult to remove. In some examples, the heuristic can be based on a use case for the images (e.g., an imaging mode employed to process the image) to be processed using the selected image processing scheme, and how important image quality (e.g., an image quality requirement and/or image quality threshold) is to that use case. For instance, image quality may be more important if the resulting image is to be presented to human viewers than if the resulting image is to be fed into an artificial intelligence (AI) model or machine learning (ML) model, for instance for object recognition and/or classification. Thus, in use cases (e.g., imaging modes) where image quality is more important (e.g., image quality requirements and/or thresholds are higher), the imaging system can select an image processing that does more image processing operations on the headset and fewer image processing operations on the host device, like the first image processing scheme 300 or the second image processing scheme 400. On the other hand, in use cases (e.g., imaging modes) where image quality is less important (e.g., image quality requirements and/or thresholds are lower), the imaging system can select an image processing that does fewer image processing operations on the headset and more image processing operations on the host device, like the third image processing scheme 500 or the fourth image processing scheme 600.

In some examples, the heuristic can be based on an ambient light level in the environment that the headset is in (e.g., night vs. day, or lights on vs. lights off) as determined using camera(s) of the headset or ambient light sensor(s) of the headset. In some cases, image quality is already compromised in dark environments (e.g., due to blurriness caused by long exposure times or noise caused by increased gain), so it may be beneficial to avoid adding compression artifacts on top of this. For instance, if the ambient light level is below a threshold (indicating a dark environment), the imaging system can select an image processing that does more image processing operations on the headset and fewer image processing operations on the host device, like the first image processing scheme 300 or the second image processing scheme 400. On the other hand, if the ambient light level is above the threshold (indicating a bright environment), the imaging system can select an image processing that does fewer image processing operations on the headset and more image processing operations on the host device, like the third image processing scheme 500 or the fourth image processing scheme 600. Further still, in some cases, image quality is compromised in very bright environments (e.g., due to overexposure), so it may be beneficial to avoid adding compression artifacts (e.g., additional reduction in image quality) on top of this compromised image quality caused by very bright environment environments. For instance, if the ambient light level is above a second threshold (indicating a very bright environment in which overexposure is likely), the imaging system can select an image processing that does more image processing operations on the headset and fewer image processing operations on the host device, like the first image processing scheme 300 or the second image processing scheme 400.

In some examples, the imaging system may include respective power models of the headset and/or the host device that the imaging system can use in calculating the heuristic. The power models may allow the imaging system to estimate how much power certain tasks may use, and/or how much heat may be generated by performing certain tasks. In calculating the heuristic, the imaging system can use the power model to ensure that offloading a specific task from the headset to the host device actually results in a net reduction in heat generated and/or battery charge used. For instance, if the headset is to offload stabilization to the host device, the headset must send pre-stabilization image data to the host device. Since stabilization generally involves cropping portions of image data (as well as various rotations and/or translations as needed), the pre-stabilization image data actually includes more image data (e.g., more pixels) than post-stabilization image data. The imaging system can consult the power model to ensure that offloading stabilization to the host device reduces power usage and/or heat generation more than the small increase in power usage and/or heat generation caused by sending the pre-stabilization image data from the headset to the host device (and thus more pixels) instead of sending post-stabilization image data from the headset to the host device.

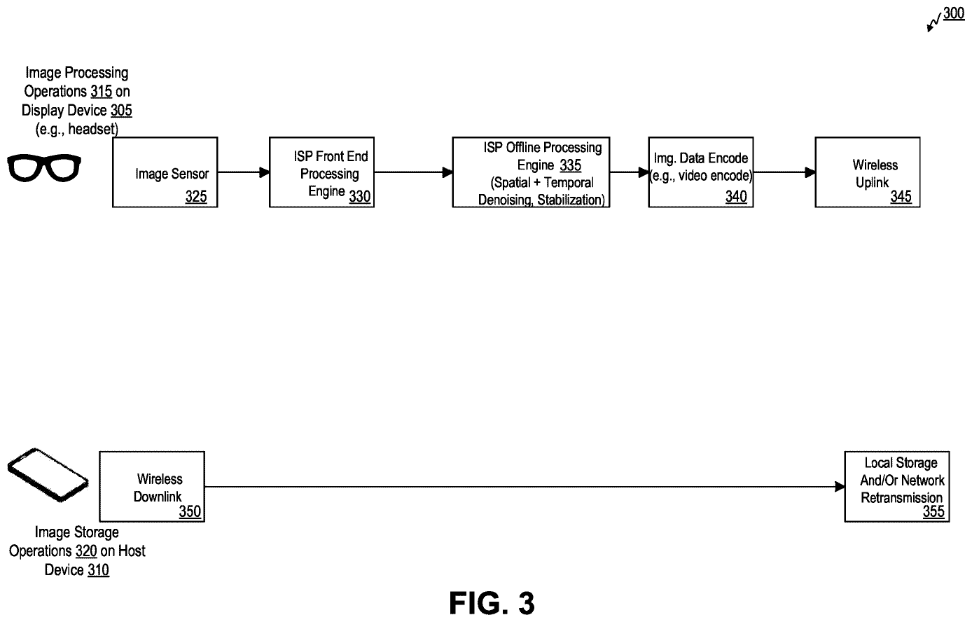

FIG. 3 is a flow diagram illustrating a first image processing scheme 300 with some image processing operations 315 performed using a display device 305 (e.g., headset) and some image storage operations 320 performed using a host device 310. The image processing operations 315 performed using the display device 305 under the first image processing scheme 300 include capture of image data (e.g., video data) using an image sensor 325. The image sensor 325 can be an example of the image capture and processing system 100, the image capture device 105A, the image processing device 105B, the image sensor 130, and/or any cameras or image sensors discussed herein. The image processing operations 315 performed using the display device 305 include use of an ISP front-end processing engine 330 to apply certain processing operations (e.g., demosaicing, pixel correction, pixel compensation, color space conversion, auto-exposure control, auto-focus, auto-white-balance, automatic gain control, and/or other operations discussed with respect to the ISP 154) to the image data from the image sensor 325. The image processing operations 315 performed using the display device 305 include stabilization, temporal denoising, and spatial denoising using an ISP offline processing engine 335. The image processing operations 315 performed using the display device 305 include encoding (e.g., compressing) image data (e.g., video data) using an image data encoder 340 (e.g., video encoder) and transmitting the image data to the host device 310 using the wireless uplink 345 (e.g., Wi-Fi, Bluetooth®, personal area network (PAN), cellular network, or another wireless or wired interface).

The image storage operations 320 performed using the host device 310 under the first image processing scheme 300 include receiving the image data (e.g., video data) from the display device 305 using the wireless downlink 350 (e.g., Wi-Fi, Bluetooth®, PAN, cellular network, or another wireless or wired interface), then storing and/or transmitting the image data (e.g., video data) using local storage and/or network retransmission 355 (e.g., retransmission back to the display device 305 to be decoded by an image data decoder and/or video decoder at the display device 305 and displayed using a display of the display device 305).

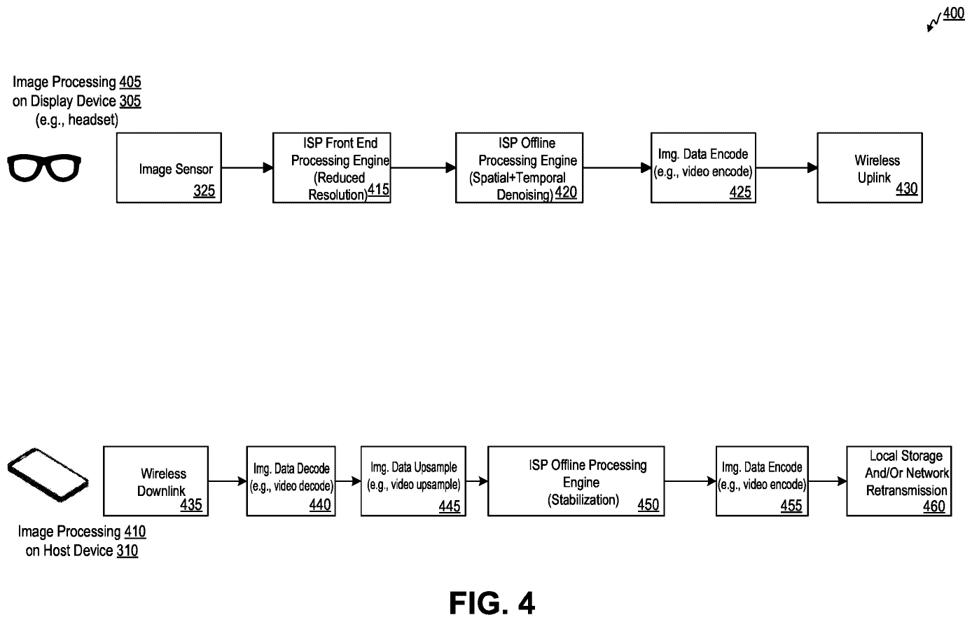

FIG. 4 is a flow diagram illustrating a second image processing scheme 400 with some image processing operations 405 performed using a display device 305 (e.g., headset) and some image processing operations 410 (including stabilization) performed using a host device 310. The image processing operations 405 performed using the display device 305 under the second image processing scheme 400 include capture of image data (e.g., video data) using the image sensor 325 and use of an ISP front-end processing engine 415 to apply certain processing operations (such as those discussed with respect to the ISP front-end processing engine 330 and/or the ISP 154) to the image data from the image sensor 325. The image processing operations 405 performed using the display device 305 include temporal denoising and spatial denoising using an ISP offline processing engine 420 of the display device 305. The image processing operations 405 performed using the display device 305 include encoding (e.g., compressing) image data (e.g., video data) using an image data encoder 425 (e.g., video encoder) of the display device 305 and transmitting the image data to the host device 310 using the wireless uplink 430 (e.g., wireless uplink 345).

The image processing operations 410 performed using the host device 310 under the second image processing scheme 400 include receiving the image data (e.g., video data) from the display device 305 using the wireless downlink 435 (e.g., wireless downlink 350) and decoding (e.g., decompressing) the image data (e.g., video data) using an image data decoder 440 (e.g., video decoder). In some examples, the image processing operations 410 performed using the host device 310 include upsampling the image data (e.g., using an upsampler 445) before or after decoding the image data. The image processing operations 410 performed using the host device 310 include stabilization using an ISP offline processing engine 450 of the host device 310. By offloading stabilization from the display device 305 to the host device 310, the second image processing scheme 400 reduces power usage by the display device 305 and heat generation by the display device 305 compared to the first image processing scheme 300. The image processing operations 410 performed using the host device 310 include encoding (e.g., compressing) the stabilized image data (e.g., stabilized video data) using an image data encoder 455 (e.g., video encoder) of the host device 310 and storing and/or transmitting the image data (e.g., video data) using local storage and/or network retransmission 460 (e.g., retransmission back to the display device 305 to be decoded by an image data decoder and/or video decoder at the display device 305 and displayed using a display of the display device 305).

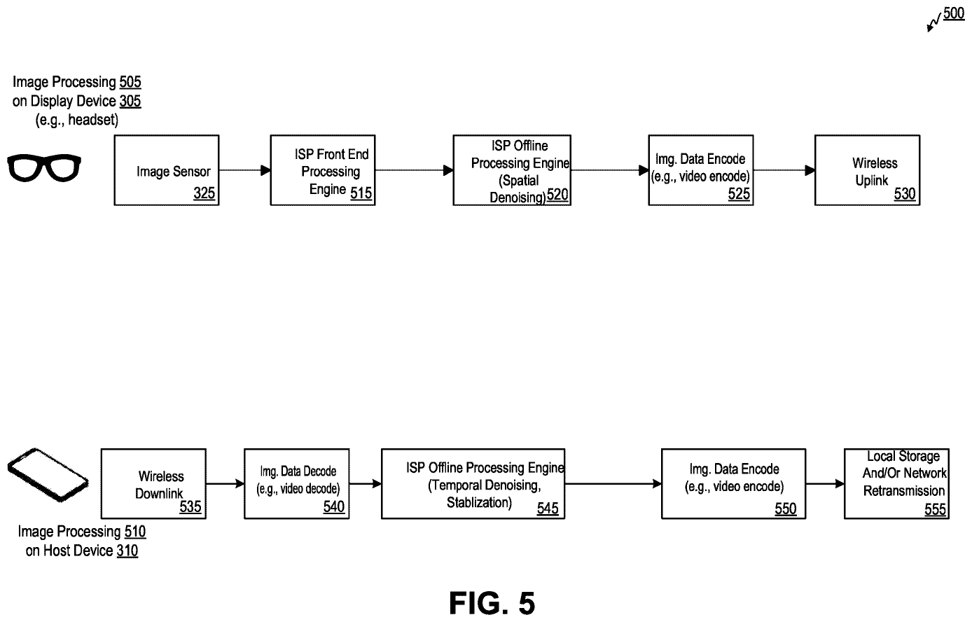

FIG. 5 is a flow diagram illustrating a third image processing scheme 500 with some image processing operations 505 performed using a display device 305 (e.g., headset) and some image processing operations 510 (including stabilization and temporal denoising) performed using a host device 310. The image processing operations 505 performed using the display device 305 under the third image processing scheme 500 include capture of image data (e.g., video data) using the image sensor 325 and use of an ISP front-end processing engine 515 to apply certain processing operations (such as those discussed with respect to the ISP front-end processing engine 330 and/or the ISP 154) to the image data from the image sensor 325. The image processing operations 505 performed using the display device 305 include spatial denoising using an ISP offline processing engine 520 of the display device 305. The image processing operations 505 performed using the display device 305 include encoding (e.g., compressing) image data (e.g., video data) using an image data encoder 525 (e.g., video encoder) of the display device 305 and transmitting the image data to the host device 310 using the wireless uplink 530 (e.g., wireless uplink 345).

The image processing operations 510 performed using the host device 310 under the third image processing scheme 500 include receiving the image data (e.g., video data) from the display device 305 using the wireless downlink 535 (e.g., wireless downlink 350) and decoding (e.g., decompressing) the image data (e.g., video data) using an image data decoder 540 (e.g., video decoder). In some examples, the image processing operations 510 performed using the host device 310 include upsampling the image data before or after decoding the image data. The image processing operations 510 performed using the host device 310 include stabilization and temporal denoising using an ISP offline processing engine 545 of the host device 310. By offloading stabilization and temporal denoising from the display device 305 to the host device 310, the third image processing scheme 500 reduces power usage by the display device 305 and heat generation by the display device 305 compared to the first image processing scheme 300 and the second image processing scheme 400. The image processing operations 510 performed using the host device 310 include encoding (e.g., compressing) the stabilized image data (e.g., stabilized video data) using an image data encoder 550 (e.g., video encoder) of the host device 310 and storing and/or transmitting the image data (e.g., video data) using local storage and/or network retransmission 555 (e.g., retransmission back to the display device 305 to be decoded by an image data decoder and/or video decoder at the display device 305 and displayed using a display of the display device 305).

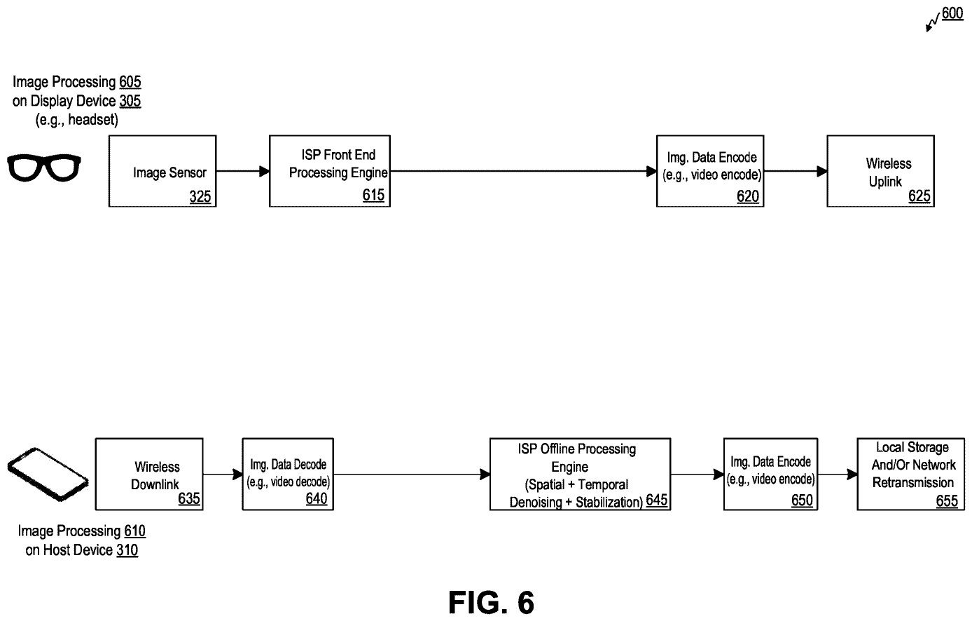

FIG. 6 is a flow diagram illustrating a fourth image processing scheme 600 with some image processing operations 605 performed using a display device 305 (e.g., headset) and some image processing operations 610 (including stabilization, temporal denoising, and spatial denoising) performed using a host device 310. The image processing operations 605 performed using the display device 305 under the fourth image processing scheme 600 include capture of image data (e.g., video data) using the image sensor 325 and use of an ISP front-end processing engine 615 to apply certain processing operations (such as those discussed with respect to the ISP front-end processing engine 330 and/or the ISP 154) to the image data from the image sensor 325. The image processing operations 605 performed using the display device 305 include encoding (e.g., compressing) image data (e.g., video data) using an image data encoder 620 of the display device 305 and transmitting the image data to the host device 310 using the wireless uplink 625 (e.g., wireless uplink 345). In some examples, the image processing operations 610 are performed without performing any ISP offline processing engine operations at the display device 305. In some examples, the display device 305 may be missing an ISP offline processing engine.

The image processing operations 610 performed using the host device 310 under the fourth image processing scheme 600 include receiving the image data (e.g., video data) from the display device 305 using the wireless downlink 635 (e.g., wireless downlink 350) and decoding (e.g., decompressing) the image data (e.g., video data) using an image decoder 640 (e.g., video decoder). In some examples, the image processing operations 610 performed using the host device 310 include upsampling the image data before or after decoding the image data. The image processing operations 610 performed using the host device 310 include stabilization, temporal denoising, and spatial denoising using an ISP offline processing engine 645 of the host device 310. By offloading stabilization, temporal denoising, and spatial denoising from the display device 305 to the host device 310, the fourth image processing scheme 600 reduces power usage by the display device 305 and heat generation by the display device 305 compared to the first image processing scheme 300, the second image processing scheme 400, and the third image processing scheme 500. The image processing operations 610 performed using the host device 310 include encoding (e.g., compressing) the stabilized image data (e.g., stabilized video data) using an image data encoder 650 of the host device 310 and performing local storage and/or network retransmission 655 (e.g., retransmission back to the display device 305 to be decoded by an image data decoder and/or video decoder at the display device 305 and displayed using a display of the display device 305).

In some examples, additional image processing operations can be shifted between being performed by the display device 305 and being performed by the host device 310 instead of or in addition to stabilization, temporal denoising, and spatial denoising, depending on the image processing scheme selected to be used by the imaging system. These additional image processing operations can include, for example, super-resolution, filtering, machine learning based denoising, machine learning based sharpening, color changes, contrast changes, saturation changes, tone mapping, white balance changes, black balance changes, any other image processing operations discussed herein, or a combination thereof.

In some examples, the display device 305 and/or the host device 310 can adjust characteristics of the coupling (e.g., the connection) between the display device 305 and the host device 310, for instance to modify bit rate, baud rate, bandwidth, frequency (or frequency range), wavelength (or wavelength range), latency, protocol, transmission power, error checking and/or correction (ECC) scheme(s), or a combination thereof. For instance, the display device 305 and/or the host device 310 can adjust characteristics of the coupling (e.g., the connection) between the display device 305 and the host device 310 based on which processing operations (e.g., stabilization, temporal denoising, and/or spatial denoising) are being offloaded from the display device 305 to the host device 310 and which processing operations are remaining to be performed by the display device 305.

In some examples, for instance, offloading temporal denoising and/or spatial denoising from the display device 305 to the host device 310 (e.g., as in the image processing operations 510 of FIG. 5 and/or the image processing operations 610 of FIG. 6) benefits from preserving as much detail as possible in order to preserve image quality. In some examples, to accommodate the higher image quality, the display device 305 and/or the host device 310 can increase the bitrate of the coupling (e.g., the connection) between the display device 305 and the host device 310, for instance by multiplying a bit rate of the coupling (e.g., the connection) by 2.4 or another multiplier. This allows the display device 305 to send a video stream from the display device 305 to the host device 310 at a higher level of quality to make up for any image degradation that may occur due to compressing the video stream at the display device 305 and decompressing the video steam at the host device 310 before applying the image processing operations, and due to compressing the processed video stream at the host device 310 and decompressing the video steam at the display device 305 after applying the image processing operations. In some examples, certain denoising operations can present a heightened risk of such image degradation (e.g., compared to stabilization), hence the increased bit rate to start with higher-quality images to compensate for the potential image degradation.

On the other hand, if only image stabilization js offloaded from the display device 305 to the host device 310 (e.g., as in the image processing operations 410 of FIG. 4), the display device 305 and/or the host device 310 can increase the bitrate of the coupling (e.g., the connection) between the display device 305 and the host device 310 by a smaller amount, for instance by multiplying a bit rate of the coupling (e.g., the connection) by 1.4 or another multiplier. Similarly, if partial denoising (e.g., spatial denoising or temporal denoising but not both) js offloaded from the display device 305 to the host device 310 (e.g., with stabilization as in the image processing operations 510 of FIG. 5 or without stabilization), the display device 305 and/or the host device 310 can increase the bitrate of the coupling (e.g., the connection) between the display device 305 and the host device 310 by a mid-range amount, for instance by multiplying a bit rate of the coupling (e.g., the connection) by a multiplier between 1.4 and 2.4.

In some examples, the display device 305 and/or the host device 310 can perform an image quality impact analysis to identify, based on which image processing operations are being offloaded from the display device 305 to the host device 310, which video stream is to be sent from the display device 305 to the host device 310 (e.g., which of several possible options for image quality, resolution, and/or compression scheme) and which characteristics (e.g., bit rate) should be applied to the coupling (e.g., the connection) between the display device 305 and the host device 310. In some examples, predetermined associations between image processing operations to be offloaded, video stream quality options, and coupling characteristics (e.g., bit rate) can be stored in a data structure, such as a lookup table (LUT). In some examples, the image quality impact analysis can include querying the data structure (e.g., the LUT) with the image processing operations to be offloaded to determine associated video stream quality options and/or coupling characteristics (e.g., bit rate).

In some examples, the coupling (e.g., the connection) between the display device 305 and the host device 310 is wired. In some examples, the coupling (e.g., the connection) between the display device 305 and the host device 310 is wireless (e.g., Wi-Fi, Bluetooth®, PAN, cellular network). In some examples, the display device 305 and/or the host device 310 can adjust characteristics of the coupling (e.g., the connection) between the display device 305 and the host device 310 based on conditions associated with the coupling (e.g., the connection). For instance, if the coupling (e.g., the connection) is wireless, and the wireless channel conditions are noisy, then the display device 305 and/or the host device 310 can adjust (e.g., increase) transmission power to overcome the noisiness of the channel, can adjust the ECC to accommodate potential loss or packets or errors in packets along the noisy channel, can change channels to a less noisy channel, or a combination thereof. In some examples, predetermined associations between condition(s) of the coupling (e.g., the connection) and characteristic(s) of the coupling (e.g., the connection) to be modified can be stored in a data structure, such as a lookup table (LUT). In some examples, the display device 305 and/or the host device 310 can perform a coupling analysis to identify, based on the condition(s) of the coupling (e.g., the connection), the characteristic(s) of the coupling (e.g., the connection), for instance based on the data structure.

In some examples, the display device 305 and/or the host device 310 can calculate one or more heuristics and compare the heuristic(s) to one or more thresholds to determine whether or not offloading one or more particular image processing operations will result in a net reduction in power usage by the display device 305. If offloading the image processing operation(s) will result in a net reduction in power usage by the display device 305, the display device 305 can offload the image processing operation(s), however, if offloading the image processing operation(s) will not result in a net reduction in power usage by the display device 305 (e.g., will break even or result in a net increase in power usage by the display device 305), the display device 305 can decline to offload the image processing operation(s) (e.g., the display device 305 can perform the image processing operation(s) itself). For instance, if the display device 305 plans to offload one or more image processing operations to the host device 310, but a noisy channel of the coupling (e.g., the connection) causes the display device 305 to increase transmission power of transmissions to the host device 310 by a specific amount that exceeds the power saving amount that the host device 310 would gain from offloading the image processing operation(s) to the host device 310, then the display device 305 can decide not to offload the image processing operation(s) (e.g., the display device 305 can perform the image processing operation(s) itself) to maintain a lower net power usage by the display device 305.

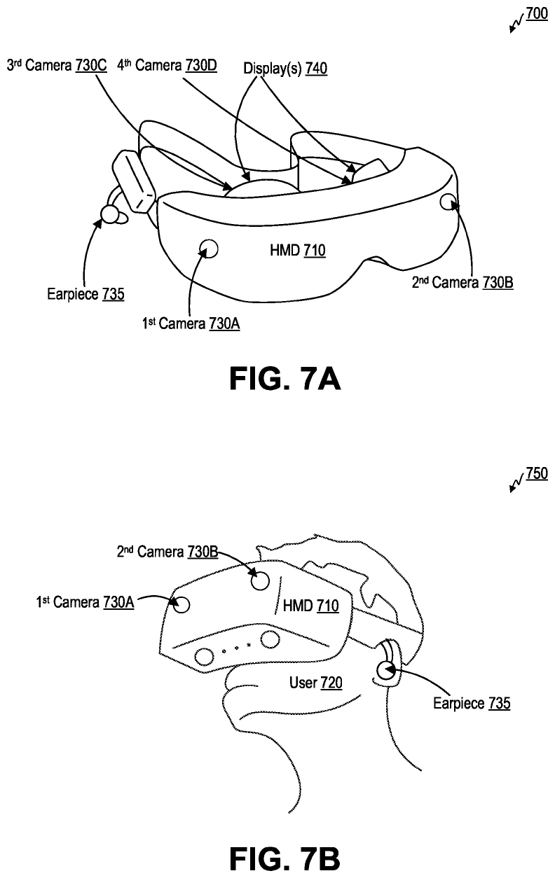

FIG. 7A is a perspective diagram 700 illustrating a head-mounted display (HMD) 710 that is used as part of an imaging system (e.g., the imaging system(s) of any of FIGS. 2-6). The HMD 710 may be, for example, an augmented reality (AR) headset, a virtual reality (VR) headset, a mixed reality (MR) headset, an extended reality (XR) headset, or some combination thereof. The HMD 710 may be an example of a display device 305 and/or of an imaging system (e.g., the imaging system(s) of any of FIGS. 2-6). The HMD 710 includes a first camera 730A and a second camera 730B along a front portion of the HMD 710. The first camera 730A and the second camera 730B may be examples of image sensor(s) 325 of the imaging system (e.g., the imaging system(s) of any of FIGS. 2-6). The HMD 710 includes a third camera 730C and a fourth camera 730D facing the eye(s) of the user as the eye(s) of the user face the display(s) 740. The third camera 730C and the fourth camera 730D may be examples of image sensor(s) 325 of the imaging system (e.g., the imaging system(s) of any of FIGS. 2-6). In some examples, the HMD 710 may only have a single camera with a single image sensor. In some examples, the HMD 710 may include one or more additional cameras in addition to the first camera 730A, the second camera 730B, third camera 730C, and the fourth camera 730D. In some examples, the HMD 710 may include one or more additional sensors in addition to the first camera 730A, the second camera 730B, third camera 730C, and the fourth camera 730D, which may also include other types of image sensor(s) of the imaging system (e.g., the imaging system(s) of any of FIGS. 2-6). In some examples, the first camera 730A, the second camera 730B, third camera 730C, and/or the fourth camera 730D may be examples of the image capture and processing system 100, the image capture device 105A, the image processing device 105B, or a combination thereof. In some examples, any of the first camera 730A, the second camera 730B, third camera 730C, and/or the fourth camera 730D can be, or can include, depth sensors.

The HMD 710 may include one or more displays 740 that are visible to a user 720 wearing the HMD 710 on the user 720's head. The one or more displays 740 of the HMD 710 can be examples of the one or more displays of the output device(s) 1235 of the computing system 1200. In some examples, the HMD 710 may include one display 740 and two viewfinders. The two viewfinders can include a left viewfinder for the user 720's left eye and a right viewfinder for the user 720's right eye. The left viewfinder can be oriented so that the left eye of the user 720 sees a left side of the display. The right viewfinder can be oriented so that the right eye of the user 720 sees a right side of the display. In some examples, the HMD 710 may include two displays 740, including a left display that displays content to the user 720's left eye and a right display that displays content to a user 720's right eye. The one or more displays 740 of the HMD 710 can be digital “pass-through” displays or optical “see-through” displays The HMD 710 may include one or more earpieces 735, which may function as speakers and/or headphones that output audio to one or more ears of a user of the HMD 710, and may be examples of output device(s) 1235 of the computing system 1200. One earpiece 735 is illustrated in FIGS. 7A and 7B, but it should be understood that the HMD 710 can include two earpieces, with one earpiece for each ear (left ear and right ear) of the user. In some examples, the HMD 710 can also include one or more microphones (not pictured). The one or more microphones can be examples of the image sensor(s) 325 of the imaging system (e.g., the imaging system(s) of any of FIGS. 2-6). In some examples, the audio output by the HMD 710 to the user through the one or more earpieces 735 may include, or be based on, audio recorded using the one or more microphones.

FIG. 7B is a perspective diagram 750 illustrating the head-mounted display (HMD) of FIG. 7A being worn by a user 720. The user 720 wears the HMD 710 on the user 720's head over the user 720's eyes. The HMD 710 can capture images with the first camera 730A and the second camera 730B. In some examples, the HMD 710 displays one or more output images toward the user 720's eyes using the display(s) 740. In some examples, the output images can include image(s) processed by the display device 305 and/or the host device 310 according to any of the image processing schemes 300-600. The output images can be based on the images captured by the first camera 730A and the second camera 730B (e.g., as captured by the image sensor 325), for example processed versions and/or with the virtual content (e.g., as processed by the display device 305 and/or the host device 310 according to any of the image processing schemes 300-600) overlaid. The output images may provide a stereoscopic view of the environment, in some cases with the virtual content overlaid and/or with other modifications. For example, the HMD 710 can display a first display image to the user 720's right eye, the first display image based on an image captured by the first camera 730A. The HMD 710 can display a second display image to the user 720's left eye, the second display image based on an image captured by the second camera 730B. For instance, the HMD 710 may provide overlaid virtual content in the display images overlaid over the images captured by the first camera 730A and the second camera 730B. The third camera 730C and the fourth camera 730D can capture images of the eyes of the before, during, and/or after the user views the display images displayed by the display(s) 740. This way, the sensor data from the third camera 730C and/or the fourth camera 730D can capture reactions to the virtual content by the user's eyes (and/or other portions of the user). An earpiece 735 of the HMD 710 is illustrated in an ear of the user 720. The HMD 710 may be outputting audio to the user 720 through the earpiece 735 and/or through another earpiece (not pictured) of the HMD 710 that is in the other ear (not pictured) of the user 720.

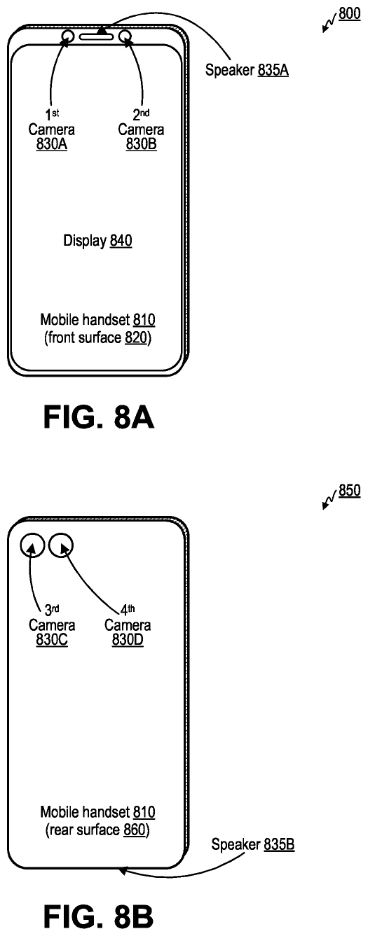

FIG. 8A is a perspective diagram 800 illustrating a front surface of a mobile handset 810 that includes front-facing cameras and can be used as part of an imaging system (e.g., imaging system (e.g., the imaging system(s) of any of FIGS. 2-6)). The mobile handset 810 may be an example of a display device 305 and/or a host device 310. The mobile handset 810 may be an example of an imaging system (e.g., the imaging system(s) of any of FIGS. 2-6). The mobile handset 810 may be, for example, a cellular telephone, a satellite phone, a portable gaming console, a music player, a health tracking device, a wearable device, a wireless communication device, a laptop, a mobile device, any other type of computing device or computing system discussed herein, or a combination thereof.

The front surface 820 of the mobile handset 810 includes a display 840. The front surface 820 of the mobile handset 810 includes a first camera 830A and a second camera 830B. The first camera 830A and the second camera 830B may be examples of the image sensor(s) 325 of the imaging system (e.g., the imaging system(s) of any of FIGS. 2-6). The first camera 830A and the second camera 830B can face the user, including the eye(s) of the user, while content (e.g., as processed by the display device 305 and/or the host device 310 according to any of the image processing schemes 300-600) is displayed on the display 840. The display 840 may be an example of the display(s) of the output device(s) 1235 of the computing system 1200.

The first camera 830A and the second camera 830B are illustrated in a bezel around the display 840 on the front surface 820 of the mobile handset 810. In some examples, the first camera 830A and the second camera 830B can be positioned in a notch or cutout that is cut out from the display 840 on the front surface 820 of the mobile handset 810. In some examples, the first camera 830A and the second camera 830B can be under-display cameras that are positioned between the display 840 and the rest of the mobile handset 810, so that light passes through a portion of the display 840 before reaching the first camera 830A and the second camera 830B. The first camera 830A and the second camera 830B of the perspective diagram 800 are front-facing cameras. The first camera 830A and the second camera 830B face a direction perpendicular to a planar surface of the front surface 820 of the mobile handset 810. The first camera 830A and the second camera 830B may be two of the one or more cameras of the mobile handset 810. In some examples, the front surface 820 of the mobile handset 810 may only have a single camera.

In some examples, the display 840 of the mobile handset 810 displays one or more output images toward the user using the mobile handset 810. In some examples, the output images can include image(s) processed by the display device 305 and/or the host device 310 according to any of the image processing schemes 300-600. The output images can be based on the images (e.g., as captured by the image sensor 325) captured by the first camera 830A, the second camera 830B, the third camera 830C, and/or the fourth camera 830D, for example processed versions and/or with the virtual content (e.g., as processed by the display device 305 and/or the host device 310 according to any of the image processing schemes 300-600) overlaid.

In some examples, the front surface 820 of the mobile handset 810 may include one or more additional cameras in addition to the first camera 830A and the second camera 830B. The one or more additional cameras may also be examples of the image sensor(s) 325 of the imaging system (e.g., the imaging system(s) of any of FIGS. 2-6). In some examples, the front surface 820 of the mobile handset 810 may include one or more additional sensors in addition to the first camera 830A and the second camera 830B. The one or more additional sensors may also be examples of the image sensor(s) 325 of the imaging system (e.g., the imaging system(s) of any of FIGS. 2-6). In some cases, the front surface 820 of the mobile handset 810 includes more than one display 840. The one or more displays 840 of the front surface 820 of the mobile handset 810 can be examples of the display(s) of the output device(s) 1235 of the computing system 1200. For example, the one or more displays 840 can include one or more touchscreen displays.

The mobile handset 810 may include one or more speakers 835A and/or other audio output devices (e.g., earphones or headphones or connectors thereto), which can output audio to one or more ears of a user of the mobile handset 810. One speaker 835A is illustrated in FIG. 8A, but it should be understood that the mobile handset 810 can include more than one speaker and/or other audio device. In some examples, the mobile handset 810 can also include one or more microphones (not pictured). The one or more microphones can be examples of the image sensor(s) 325 of the imaging system (e.g., the imaging system(s) of any of FIGS. 2-6). In some examples, the mobile handset 810 can include one or more microphones along and/or adjacent to the front surface 820 of the mobile handset 810, with these microphones being examples of sensor(s) (e.g., audio sensor(s)) of the imaging system (e.g., the imaging system(s) of any of FIGS. 2-6). In some examples, the audio output by the mobile handset 810 to the user through the one or more speakers 835A and/or other audio output devices may include, or be based on, audio recorded using the one or more microphones.

FIG. 8B is a perspective diagram 850 illustrating a rear surface 860 of a mobile handset that includes rear-facing cameras and that can be used as part of an imaging system (e.g., imaging system (e.g., the imaging system(s) of any of FIGS. 2-6)). The mobile handset 810 includes a third camera 830C and a fourth camera 830D on the rear surface 860 of the mobile handset 810. The third camera 830C and the fourth camera 830D of the perspective diagram 850 are rear-facing. The third camera 830C and the fourth camera 830D may be examples of the image sensor(s) 325 of the imaging system (e.g., the imaging system(s) of any of FIGS. 2-6) of FIGS. 2, 3, and/or 4. The third camera 830C and the fourth camera 830D face a direction perpendicular to a planar surface of the rear surface 860 of the mobile handset 810.

The third camera 830C and the fourth camera 830D may be two of the one or more cameras of the mobile handset 810. In some examples, the rear surface 860 of the mobile handset 810 may only have a single camera. In some examples, the rear surface 860 of the mobile handset 810 may include one or more additional cameras in addition to the third camera 830C and the fourth camera 830D. The one or more additional cameras may also be examples of the image sensor(s) 325 of the imaging system (e.g., the imaging system(s) of any of FIGS. 2-6). In some examples, the rear surface 860 of the mobile handset 810 may include one or more additional sensors in addition to the third camera 830C and the fourth camera 830D. The one or more additional sensors may also be examples of the image sensor(s) 325 of the imaging system (e.g., the imaging system(s) of any of FIGS. 2-6). In some examples, the first camera 830A, the second camera 830B, third camera 830C, and/or the fourth camera 830D may be examples of the image capture and processing system 100, the image capture device 105A, the image processing device 105B, or a combination thereof. In some examples, any of the first camera 830A, the second camera 830B, third camera 830C, and/or the fourth camera 830D can be, or can include, depth sensors.

The mobile handset 810 may include one or more speakers 835B and/or other audio output devices (e.g., earphones or headphones or connectors thereto), which can output audio to one or more ears of a user of the mobile handset 810. One speaker 835B is illustrated in FIG. 8B, but it should be understood that the mobile handset 810 can include more than one speaker and/or other audio device. In some examples, the mobile handset 810 can also include one or more microphones (not pictured). The one or more microphones can be examples of the image sensor(s) 325 of the imaging system (e.g., the imaging system(s) of any of FIGS. 2-6). In some examples, the mobile handset 810 can include one or more microphones along and/or adjacent to the rear surface 860 of the mobile handset 810, with these microphones being examples of the sensor(s) (e.g., audio sensor(s)) of the imaging system (e.g., the imaging system(s) of any of FIGS. 2-6). In some examples, the audio output by the mobile handset 810 to the user through the one or more speakers 835B and/or other audio output devices may include, or be based on, audio recorded using the one or more microphones.

The mobile handset 810 may use the display 840 on the front surface 820 as a pass-through display. For instance, the display 840 may display output images, such as as processed by the display device 305 and/or the host device 310 according to any of the image processing schemes 300-600. The output images can be based on the images captured by the third camera 830C and/or the fourth camera 830D, for example processed versions and/or with the virtual content (e.g., as processed by the display device 305 and/or the host device 310 according to any of the image processing schemes 300-600) overlaid. The first camera 830A and/or the second camera 830B can capture images of the user's eyes (and/or other portions of the user) before, during, and/or after the display of the output images with the virtual content on the display 840. This way, the sensor data from the first camera 830A and/or the second camera 830B can capture reactions to the virtual content by the user's eyes (and/or other portions of the user).

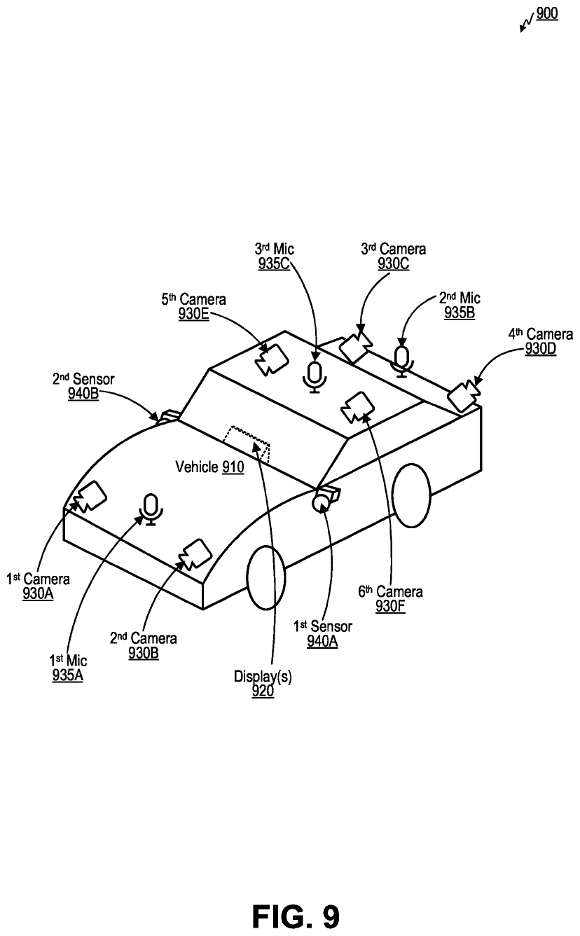

FIG. 9 is a perspective diagram 900 illustrating a vehicle 910 that includes various sensors. The vehicle 910 may be an example of one or more imaging system (e.g., the imaging system(s) of any of FIGS. 2-6). The vehicle 910 may be an example of a display device 305 and/or a host device 310. The vehicle 910 is illustrated as an automobile, but may be, for example, an automobile, a truck, a bus, a train, a ground-based vehicle, an airplane, a helicopter, an aircraft, an aerial vehicle, a boat, a submarine, a watercraft, an underwater vehicle, a hovercraft, a robot, a vacuum cleaner, another type of vehicle discussed herein, or a combination thereof. In some examples, the vehicle may be at least partially controlled and/or used with sub-systems of the vehicle 910, such as ADAS of the vehicle 910, IVI systems of the vehicle 910, control systems of the vehicle 910, a vehicle electronic control unit (ECU) of the vehicle 910, or a combination thereof.

The vehicle 910 includes a display 920. The vehicle 910 includes various sensors, all of which can be examples of the image sensor(s) 325. The vehicle 910 includes a first camera 930A and a second camera 930B at the front, a third camera 930C and a fourth camera 930D at the rear, and a fifth camera 930E and a sixth camera 930F on the top. The vehicle 910 includes a first microphone 935A at the front, a second microphone 935B at the rear, and a third microphone 935C at the top. The vehicle 910 includes a first sensor 940A on one side (e.g., adjacent to one rear-view mirror) and a second sensor 940B on another side (e.g., adjacent to another rear-view mirror). The first sensor 940A and the second sensor 940B may include cameras, microphones, depth sensors (e.g., Radio Detection and Ranging (RADAR) sensors, Light Detection and Ranging (LIDAR) sensors, Sound Detection and Ranging (SODAR) sensors, Sound Navigation and Ranging (SONAR) sensors, time of flight (ToF) sensors, structured light sensors, stereoscopic cameras, etc.), or any other types of sensors(s) described herein. In some examples, the vehicle 910 may include additional image sensor(s) in addition to the sensors illustrated in FIG. 9. In some examples, the vehicle 910 may be missing some of the sensors that are illustrated in FIG. 9.

In some examples, the display 920 of the vehicle 910 displays one or more output images toward a user of the vehicle 910 (e.g., a driver and/or one or more passengers of the vehicle 910). In some examples, the output images can include image(s) processed by the display device 305 and/or the host device 310 according to any of the image processing schemes 300-600. The output images can be based on the images (e.g., as captured by the image sensor 325) captured by the first camera 930A, the second camera 930B, the third camera 930C, the fourth camera 930D, the fifth camera 930E, the sixth camera 930F, the first sensor 940A, and/or the second sensor 940B, for example processed versions and/or with the virtual content (e.g., as processed by the display device 305 and/or the host device 310 according to any of the image processing schemes 300-600) overlaid. In some examples, any of the first camera 930A, the second camera 930B, the third camera 930C, the fourth camera 930D, the fifth camera 930E, the sixth camera 930F, the first sensor 940A, and/or the second sensor 940B can be, or can include, depth sensors.

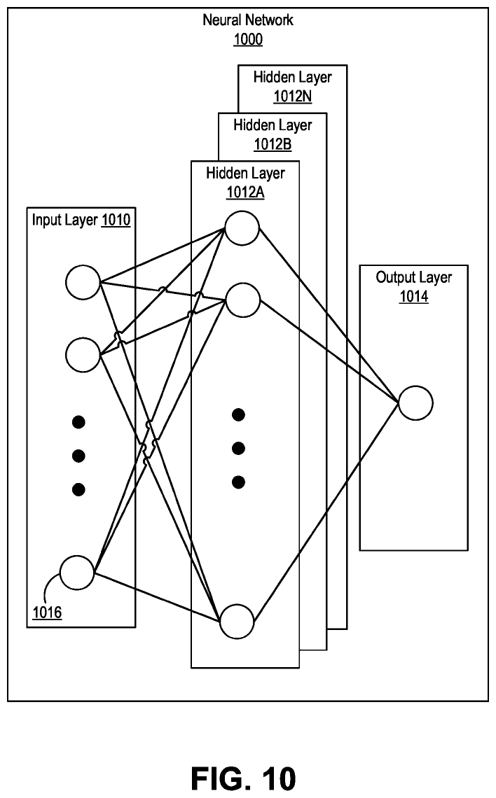

FIG. 10 is a block diagram illustrating an example of a neural network (NN) 1000 that can be used for imaging operations. The neural network 1000 can include any type of deep network, such as a convolutional neural network (CNN), an autoencoder, a deep belief net (DBN), a Recurrent Neural Network (RNN), a Generative Adversarial Networks (GAN), and/or other type of neural network. The neural network 1000 may used for certain image processing operations by the display device 305 and/or the host device 310, depending on image processing scheme, such as stabilization,, temporal denoising, spatial denoising, super-resolution, filtering, machine learning based denoising, machine learning based sharpening, color changes, contrast changes, saturation changes, tone mapping, white balance changes, black balance changes, any other image processing operations discussed herein, or a combination thereof.

An input layer 1010 of the neural network 1000 includes input data. The input data of the input layer 1010 can include data representing the pixels of one or more input image frames. In some examples, the input data of the input layer 1010 includes data representing the pixels of image data (e.g., image(s) captured by the image sensor 325, image(s) captured by one of the cameras 730A-730D, image(s) captured by one of the cameras 830A-830D, image(s) captured by one of the cameras 930A-930F, the image data of operation 1110, image(s) captured using the input device 1245, or a combination thereof). In some examples, the input data of the input layer 1010 includes processed data that is to be processed further, such as various features, weights, intermediate data, or a combination thereof.

The images can include image data from an image sensor including raw pixel data (including a single color per pixel based, for example, on a Bayer filter) or processed pixel values (e.g., RGB pixels of an RGB image). The neural network 1000 includes multiple hidden layers 1012, 1012B, through 1012N. The hidden layers 1012, 1012B, through 1012N include “N” number of hidden layers, where “N” is an integer greater than or equal to one. The number of hidden layers can be made to include as many layers as needed for the given application. The neural network 1000 further includes an output layer 1014 that provides an output resulting from the processing performed by the hidden layers 1012, 1012B, through 1012N.

In some examples, the output layer 1014 can provide output data, such as processed image data and/or video data that has been processed using stabilization,, temporal denoising, spatial denoising, super-resolution, filtering, machine learning based denoising, machine learning based sharpening, color changes, contrast changes, saturation changes, tone mapping, white balance changes, black balance changes, any other image processing operations discussed herein, or a combination thereof.

The neural network 1000 is a multi-layer neural network of interconnected filters. Each filter can be trained to learn a feature representative of the input data. Information associated with the filters is shared among the different layers and each layer retains information as information is processed. In some cases, the neural network 1000 can include a feed-forward network, in which case there are no feedback connections where outputs of the network are fed back into itself. In some cases, the network 1000 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 1010 can activate a set of nodes in the first hidden layer 1012A. For example, as shown, each of the input nodes of the input layer 1010 can be connected to each of the nodes of the first hidden layer 1012A. The nodes of a hidden layer can transform the information of each input node by applying activation functions (e.g., filters) to this information. The information derived from the transformation can then be passed to and can activate the nodes of the next hidden layer 1012B, which can perform their own designated functions. Example functions include convolutional functions, downscaling, upscaling, data transformation, and/or any other suitable functions. The output of the hidden layer 1012B can then activate nodes of the next hidden layer, and so on. The output of the last hidden layer 1012N can activate one or more nodes of the output layer 1014, which provides a processed output image. In some cases, while nodes (e.g., node 1016) in the neural network 1000 are shown as having multiple output lines, a node has a single output and all lines shown as being output from a node represent the same output value.

In some cases, each node or interconnection between nodes can have a weight that is a set of parameters derived from the training of the neural network 1000. For example, an interconnection between nodes can represent a piece of information learned about the interconnected nodes. The interconnection can have a tunable numeric weight that can be tuned (e.g., based on a training dataset), allowing the neural network 1000 to be adaptive to inputs and able to learn as more and more data is processed.

The neural network 1000 is pre-trained to process the features from the data in the input layer 1010 using the different hidden layers 1012, 1012B, through 1012N in order to provide the output through the output layer 1014.

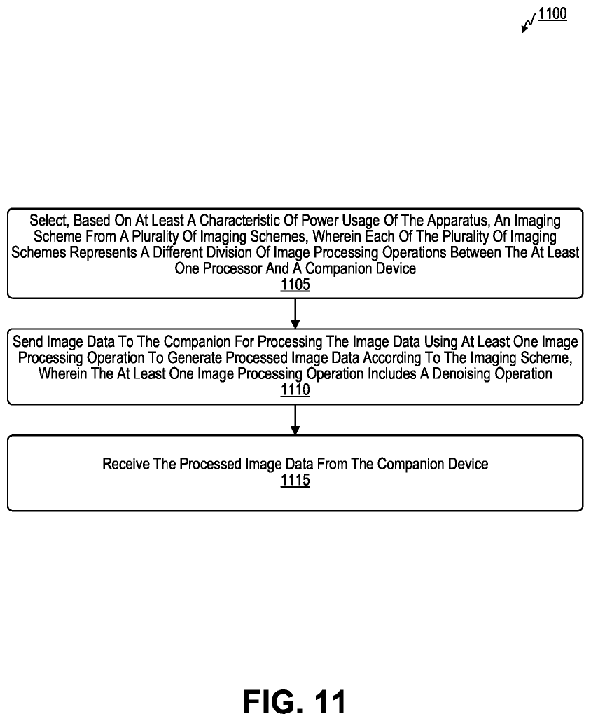

FIG. 11 is a flow diagram illustrating a process 1100 for imaging. The process 1100 for imaging may be performed by an imaging system (e.g., a chipset, a processor or multiple processors such as an ISP, host processor, application processor, or other processor, or other component). In some examples, the imaging system can include, for example, the image capture and processing system 100, the image capture device 105A, the image processing device 105B, the image processor 150, the ISP 154, the host processor 152, the imaging system that performs the process 200, the headset of the process 200, the host device of the process 200, the display device 305, the host device 310, the image sensor 325, any of the subsystems or engines of the display device 305 according to any of the image processing schemes 300-600, any of the subsystems or engines of the host device 310 according to any of the image processing schemes 300-600, the HMD 710, the mobile handset 810, the vehicle 910, the neural network 1000, the computing system 1200, the processor 1210, a system, and apparatus, a device, a non-transitory computer readable medium having stored thereon a program to be performed using a processor, or a combination thereof. In some examples, the imaging system includes a display. In some examples, the imaging system includes a transceiver and/or other communication interface(s).

At operation 1105, the imaging system (or component thereof) is configured to, and can, select, based on at least a characteristic of power usage of the apparatus, an imaging scheme (e.g., as in operations 210, 215, 220, 225, and/or 235) from a plurality of imaging schemes. Each of the plurality of imaging schemes (e.g., first imaging scheme 300, second imaging scheme 400, third imaging scheme 500, fourth imaging scheme 600) represents a different division of image processing operations between the imaging system and a companion device. In some examples, the imaging system is an example of the display device 305, and the companion device is an example of the host device 310.

In some aspects, the imaging system (or component thereof) is configured to, and can, monitor the characteristic of power usage (e.g., battery charge level and/or temperature as in operations 205 and 210, and/or a heuristic as in operation 215) of the apparatus.

In some aspects, the characteristic of power usage of the imaging system includes a battery charge level of at least one battery of the imaging system, and the imaging scheme is selected based at least in part on the battery charge level of the at least one battery of the imaging system. In some aspects, the imaging system (or component thereof) is configured to, and can, determine that the battery charge level of at least one battery of the imaging system is below a battery charge level threshold. The imaging scheme is selected over a second imaging scheme of the plurality of imaging schemes based at least in part on the battery charge level of the at least one battery of the imaging system being below the battery charge level threshold. The at least one image processing operation is configured to be performed by the imaging system rather than the companion device under the second imaging scheme.

In some aspects, the characteristic of power usage of the imaging system includes a temperature of the imaging system (e.g., as monitored at operations 205 and/or 210), wherein the imaging scheme is selected based at least in part on the temperature of the imaging system. In some aspects, the imaging system (or component thereof) is configured to, and can, determine that the temperature of the imaging system is at least at a temperature threshold (e.g., the threshold of operation 210). The imaging scheme is selected over a second imaging scheme of the plurality of imaging schemes based at least in part on the temperature of the imaging system being at least at the temperature threshold (e.g., based on proceeding to operation 215 from operation 210 as opposed to proceeding to operation 225 from operation 210). The at least one image processing operation is configured to be performed by the imaging system rather than the companion device under the second imaging scheme.

In some aspects, the imaging system (or component thereof) is configured to, and can, calculate a heuristic (e.g., the heuristic of operation 215) using at least the characteristic of power usage of the imaging system and at least one additional metric associated with the imaging system. The imaging system can select the imaging scheme from the plurality of imaging schemes based on a comparison between the heuristic and at least one heuristic threshold to select the imaging scheme.

In some aspects, the imaging system (or component thereof) is configured to, and can, determine an ambient light level in an environment that the image data is configured to depict. The imaging system can select the imaging scheme from the plurality of imaging schemes based also on the ambient light level in the environment to select the imaging scheme. In some cases, image quality is compromised in dark environments (e.g., due to blurriness caused by long exposure times or noise caused by increased gain), so it may be beneficial to avoid adding compression artifacts (e.g., additional reduction in image quality) on top of this compromised image quality caused by dark environments. For instance, if the ambient light level is below a low brightness threshold (indicating a dark environment), the imaging system can select an image processing that does more image processing operations on the headset and fewer image processing operations on the host device, like the first image processing scheme 300 or the second image processing scheme 400. On the other hand, if the ambient light level is above the low brightness threshold (indicating a relatively bright environment), the imaging system can select an image processing that does fewer image processing operations on the headset and more image processing operations on the host device, like the third image processing scheme 500 or the fourth image processing scheme 600. Further still, in some cases, image quality is compromised in very bright environments (e.g., due to overexposure), so it may be beneficial to avoid adding compression artifacts (e.g., additional reduction in image quality) on top of this compromised image quality caused by very bright environment environments. For instance, if the ambient light level is above a high brightness threshold (indicating a very bright environment in which overexposure is likely), the imaging system can select an image processing that does more image processing operations on the headset and fewer image processing operations on the host device, like the first image processing scheme 300 or the second image processing scheme 400. In some examples, the heuristic can be based on the ambient light level.

In some aspects, the imaging system (or component thereof) is configured to, and can, select the imaging scheme from the plurality of imaging schemes based also on an image quality threshold (e.g., image quality requirement or level of importance of image quality) for an imaging mode (e.g., use case) employed to process the image data. In some aspects, the imaging system (or component thereof) is configured to, and can, determine the imaging mode (e.g., use case) before selecting the imaging scheme.

In some aspects, the imaging system (or component thereof) is configured to, and can, determine, based on a power model of the imaging system, whether the imaging scheme is predicted to reduce power usage by the apparatus relative to a second imaging scheme of the plurality of imaging schemes. In some examples, the power model indicates how much power certain tasks (e.g., data transmission, data receiving, data encoding, data compression, data decoding, data decompression, temporal denoising, spatial denoising, stabilization, image processing operations, and/or combinations thereof) use (e.g., typically use, for instance on average based on previous instances) and/or are predicted or estimated to use (e.g., based on the components of the imaging system, the size and/or resolution of the image data, a type of communication interface for transmitting and/or receiving, a communication protocol, an encoding scheme, a compression scheme, or a combination thereof) at the imaging system. The imaging system can select the imaging scheme from the plurality of imaging schemes based also on whether the imaging scheme is predicted to reduce power usage by the imaging system relative to the second imaging scheme to select the imaging scheme. In some aspects, the power model is configured to factor in at least transmission power of sending the image data to the companion device, encoding power of encoding the image data before sending the image data to the companion device, or a combination thereof. For instance, in some aspects, imaging system (or component thereof) is configured to, and can, determine whether the imaging scheme is predicted to reduce power usage by the apparatus relative to the second imaging scheme based on a transmission power of sending the image data to the companion device, an encoding power of encoding the image data before sending the image data to the companion device, or a combination thereof. The transmission power and the encoding power are associated with the power model. In some aspects, the imaging system (or component thereof) is configured to, and can, select the imaging scheme from the plurality of imaging schemes based also on a transmission power of sending the image data to the companion device, an encoding power of encoding the image data before sending the image data to the companion device, or a combination thereof. Again, the transmission power and the encoding power are associated with the power model.

At operation 1110, the imaging system (or component thereof) is configured to, and can, send image data (e.g., as encoded by the image data encoder 340, the image data encoder 425, the image data encoder 525, and/or the image data encoder 620) to the companion device (e.g., using the wireless uplink 345 and wireless downlink 350, the wireless uplink 430 and wireless downlink 435, the wireless uplink 530 and wireless downlink 535, and/or the wireless uplink 625 and wireless downlink 635) for processing the image data using at least one image processing operation (e.g., upsampling, stabilization, temporal denoising, and/or spatial denoising as indicated at the upsampler 445, the ISP offline processing engine 450, the ISP offline processing engine 545, and/or the ISP offline processing engine 645) to generate processed image data (e.g., as encoded by the image data encoder 455, the image data encoder 550, and/or the image data encoder 650) according to the imaging scheme. In some examples, the image data of operation 1110 is captured using an image sensor (e.g., an image sensor of the imaging system). In an illustrative example, the at least one image processing operation includes a denoising operation (e.g., temporal denoising and/or spatial denoising).

Illustrative examples of the image sensor includes the image sensor 130, an image sensor associated with the process 200, the image sensor 325, the first camera 730A, the second camera 730B, the third camera 730C, the fourth camera 730D, the first camera 830A, the second camera 830B, the third camera 830C, the fourth camera 830D, the first camera 930A, the second camera 930B, the third camera 930C, the fourth camera 930D, the fifth camera 930E, the sixth camera 930F, the first sensor 940A, the second sensor 940B, an image sensor used to capture an image used as input data for the input layer 1010 of the NN 1000, the input device 1245, another image sensor described herein, another sensor described herein, or a combination thereof. Examples of the imaging data include the video data discussed with respect to FIGS. 3-6 and/or image data captured by any of the previously-listed image sensors.

In some aspects, the imaging system (or component thereof) is configured to, and can, adjust a characteristic of a coupling based on the imaging scheme. In some examples, to send the image data to the companion device (as in operation 1110), the imaging system can send the image data to the companion device over the coupling (e.g., after adjusting the characteristic). In some examples, the characteristic of the coupling includes a bit rate, a baud rate, a bandwidth, a frequency (or frequency range), a wavelength (or wavelength range), aa latency, a protocol, a transmission power, an error checking and/or correction (ECC) scheme(s), or a combination thereof. In an illustrative example, the characteristic of the coupling includes a bit rate. For instance, bit rate (and/or another one or more of the characteristics of the coupling listed above) can be increased under a first imaging scheme, maintained under a second imaging scheme, and/or reduced under a third imaging scheme.

In some aspects, the at least one image processing operation includes image stabilization (e.g., offloaded under the second image processing scheme 400, the third image processing scheme 500, and the fourth image processing scheme 600), temporal denoising (e.g., offloaded under the third image processing scheme 500 and the fourth image processing scheme 600), spatial denoising (e.g., offloaded under the fourth image processing scheme 600), super-resolution, filtering, upsampling, resampling, ML-based denoising (e.g., temporal and/or spatial), sharpening, tone mapping, saturation adjustment, another image processing operation discussed herein, or a combination thereof.

At operation 1115, the imaging system (or component thereof) is configured to, and can, receive the processed image data from the companion device (e.g., via the local storage and/or network retransmission 355, the local storage and/or network retransmission 460, the local storage and/or network retransmission 555, the local storage and/or network retransmission 655).

In some aspects, the companion device is separate from the imaging system. In some aspects, the imaging system is coupled to the companion device using a communication interface (e.g., a wired communication interface, a wireless communication interface, or a combination thereof). In some aspects, the imaging system includes a head-mounted display (HMD) device (e.g., display device 305, HMD 710), and the companion device includes a portable computing device (e.g., host device 310, mobile handset 810, vehicle 910) that is communicatively coupled to the imaging system using a communication interface. In some aspects, the communication interface is wireless. In some aspects, the communication interface is wired.

In some examples, the processes described herein (e.g., the process of FIG. 1, the process 200 of FIG. 2, the process of FIG. 3, the process of FIG. 4, the process of FIG. 5, the process of FIG. 6, the process of FIG. 10, the process 1100 of FIG. 11, and/or other processes described herein) may be performed by a computing device or apparatus. In some examples, the processes described herein can be performed by the image capture and processing system 100, the image capture device 105A, the image processing device 105B, the image processor 150, the ISP 154, the host processor 152, the imaging system that performs the process 200, the headset of the process 200, the host device of the process 200, the display device 305, the host device 310, the image sensor 325, any of the subsystems or engines of the display device 305 according to any of the image processing schemes 300-600, any of the subsystems or engines of the host device 310 according to any of the image processing schemes 300-600, the HMD 710, the mobile handset 810, the vehicle 910, the neural network 1000, the computing system 1200, the processor 1210, or a combination thereof.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, a vehicle or computing device of a vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes described herein are illustrated as logical flow diagrams, block diagrams, or conceptual diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

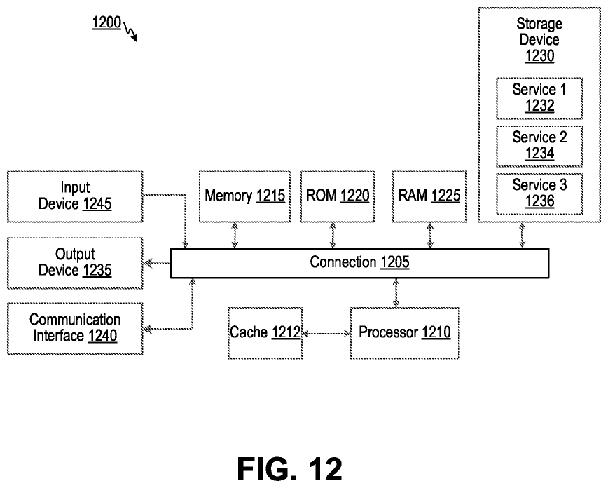

FIG. 12 is a diagram illustrating an example of a system for implementing certain aspects of the present technology. In particular, FIG. 12 illustrates an example of computing system 1200, which can be for example any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some aspects, computing system 1200 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1200 includes at least one processing unit (CPU or processor) 1210 and connection 1205 that couples various system components including system memory 1215, such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200. Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1202.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some aspects, a hardware service that performs a particular function can include the software component stored in a computer-readable medium in connection with the necessary hardware components, such as processor 1210, connection 1205, output device 1235, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Illustrative aspects of the disclosure include:

Aspect 1. An apparatus for imaging, the apparatus comprising: a memory; and at least one processor (e.g., implemented in circuitry) coupled to the memory and configured to: select, based on at least a characteristic of power usage of the apparatus, an imaging scheme from a plurality of imaging schemes, wherein each of the plurality of imaging schemes represents a different division of image processing operations between the at least one processor and a companion device; send image data to the companion device for processing the image data using at least one image processing operation to generate processed image data according to the imaging scheme, wherein the at least one image processing operation includes a denoising operation; and receive the processed image data from the companion device.

Aspect 2. The apparatus of Aspect 1, wherein the characteristic of power usage of the apparatus includes a battery charge level of at least one battery of the apparatus, wherein the imaging scheme is selected based at least in part on the battery charge level of the at least one battery of the apparatus.

Aspect 3. The apparatus of Aspect 2, wherein the at least one processor is configured to: determine that the battery charge level of at least one battery of the apparatus is below a battery charge level threshold, wherein the imaging scheme is selected over a second imaging scheme of the plurality of imaging schemes based at least in part on the battery charge level of the at least one battery of the apparatus being below the battery charge level threshold, wherein the at least one image processing operation is configured to be performed by the at least one processor rather than the companion device under the second imaging scheme.

Aspect 4. The apparatus of any of Aspects 1 to 3, wherein the characteristic of power usage of the apparatus includes a temperature of the apparatus, wherein the imaging scheme is selected based at least in part on the temperature of the apparatus.

Aspect 5. The apparatus of Aspect 4, wherein the at least one processor is configured to: determine that the temperature of the apparatus is at least at a temperature threshold, wherein the imaging scheme is selected over a second imaging scheme of the plurality of imaging schemes based at least in part on the temperature of the apparatus being at least at the temperature threshold, wherein the at least one image processing operation is configured to be performed by the at least one processor rather than the companion device under the second imaging scheme.

Aspect 6. The apparatus of any of Aspects 1 to 5, wherein the at least one processor is configured to: calculate a heuristic using at least the characteristic of power usage of the apparatus and at least one additional metric associated with the apparatus; and select the imaging scheme from the plurality of imaging schemes based on a comparison between the heuristic and at least one heuristic threshold to select the imaging scheme.

Aspect 7. The apparatus of any of Aspects 1 to 6, wherein the at least one processor is configured to: determine an ambient light level in an environment that the image data is configured to depict; and select the imaging scheme from the plurality of imaging schemes based also on the ambient light level in the environment to select the imaging scheme.

Aspect 8. The apparatus of any of Aspects 1 to 7, wherein the at least one processor is configured to: select the imaging scheme from the plurality of imaging schemes based also on an image quality threshold for an imaging mode employed to process the image data.

Aspect 9. The apparatus of any of Aspects 1 to 8, wherein the at least one processor is configured to: determine, based on a power model of the apparatus, whether the imaging scheme is predicted to reduce power usage by the apparatus relative to a second imaging scheme of the plurality of imaging schemes; and select the imaging scheme from the plurality of imaging schemes based also on whether the imaging scheme is predicted to reduce power usage by the apparatus relative to the second imaging scheme to select the imaging scheme.

Aspect 10. The apparatus of any of Aspects 1 to 9, wherein the at least one processor is configured to: select the imaging scheme from the plurality of imaging schemes based also on a transmission power of sending the image data to the companion device, wherein the transmission power is associated with a power model.

Aspect 11. The apparatus of any of Aspects 1 to 10, wherein the at least one processor is configured to: select the imaging scheme from the plurality of imaging schemes based also on an encoding power of encoding the image data before sending the image data to the companion device, wherein the encoding power is associated with a power model.

Aspect 12. The apparatus of any of Aspects 1 to 11, wherein the at least one processor is configured to: adjust a characteristic of a coupling based on the imaging scheme; and send the image data to the companion device over the coupling to send the image data to the companion device.

Aspect 13. The apparatus of Aspect 12, wherein the characteristic of the coupling includes a bit rate.

Aspect 14. The apparatus of any of Aspects 1 to 13, wherein the at least one image processing operation includes image stabilization.

Aspect 15. The apparatus of any of Aspects 1 to 14, wherein the denoising operation includes temporal denoising.

Aspect 16. The apparatus of any of Aspects 1 to 15, wherein the denoising operation includes spatial denoising.

Aspect 17. The apparatus of any of Aspects 1 to 16, wherein the at least one image processing operation includes at least one of super-resolution or filtering.

Aspect 18. The apparatus of any of Aspects 1 to 17, wherein the apparatus includes a head-mounted display (HMD) device, and wherein the companion device includes a portable computing device that is communicatively coupled to the apparatus using a communication interface.

Aspect 19. The apparatus of any of Aspects 1 to 18, wherein the companion device is separate from the apparatus

Aspect 20. The apparatus of any of Aspects 1 to 19, wherein the apparatus is coupled to the companion device using a wireless communication interface.

Aspect 21. A method of imaging, the method comprising: selecting, based on at least a characteristic of power usage of an apparatus, an imaging scheme from a plurality of imaging schemes, wherein each of the plurality of imaging schemes represents a different division of image processing operations between the apparatus and a companion device; sending image data to the companion device for processing the image data using at least one image processing operation to generate processed image data according to the imaging scheme, wherein the at least one image processing operation includes a denoising operation; and receiving the processed image data from the companion device.

Aspect 22. A non-transitory computer-readable medium having stored thereon instructions that, when executed by one or more processors, cause the one or more processors to perform operations according to any of Aspects 1 to 21.

Aspect 23. An apparatus for imaging, the apparatus comprising one or more means for performing operations according to any of Aspects 1 to 21.

What is claimed is:

1. An apparatus for imaging, the apparatus comprising:
at least one memory; and
at least one processor coupled to the at least one memory and configured to:
select, based on at least a characteristic of power usage of the apparatus, an imaging scheme from a plurality of imaging schemes, wherein each of the plurality of imaging schemes represents a different division of image processing operations between the at least one processor and a companion device;
send image data to the companion device for processing the image data using at least one image processing operation to generate processed image data according to the imaging scheme, wherein the at least one image processing operation includes a denoising operation; and
receive the processed image data from the companion device.

2. The apparatus of claim 1, wherein the characteristic of power usage of the apparatus includes a battery charge level of at least one battery of the apparatus, wherein the imaging scheme is selected based at least in part on the battery charge level of the at least one battery of the apparatus.

3. The apparatus of claim 2, wherein the at least one processor is configured to:
determine that the battery charge level of at least one battery of the apparatus is below a battery charge level threshold, wherein the imaging scheme is selected over a second imaging scheme of the plurality of imaging schemes based at least in part on the battery charge level of the at least one battery of the apparatus being below the battery charge level threshold, wherein the at least one image processing operation is configured to be performed by the at least one processor rather than the companion device under the second imaging scheme.

4. The apparatus of claim 1, wherein the characteristic of power usage of the apparatus includes a temperature of the apparatus, wherein the imaging scheme is selected based at least in part on the temperature of the apparatus.

5. The apparatus of claim 4, wherein the at least one processor is configured to:
determine that the temperature of the apparatus is at least at a temperature threshold, wherein the imaging scheme is selected over a second imaging scheme of the plurality of imaging schemes based at least in part on the temperature of the apparatus being at least at the temperature threshold, wherein the at least one image processing operation is configured to be performed by the at least one processor rather than the companion device under the second imaging scheme.

6. The apparatus of claim 1, wherein the at least one processor is configured to:
calculate a heuristic using at least the characteristic of power usage of the apparatus and at least one additional metric associated with the apparatus; and
select the imaging scheme from the plurality of imaging schemes based on a comparison between the heuristic and at least one heuristic threshold to select the imaging scheme.

7. The apparatus of claim 1, wherein the at least one processor is configured to:
determine an ambient light level in an environment that the image data is configured to depict; and
select the imaging scheme from the plurality of imaging schemes based also on the ambient light level in the environment to select the imaging scheme.

8. The apparatus of claim 1, wherein the at least one processor is configured to:
select the imaging scheme from the plurality of imaging schemes based also on an image quality threshold for an imaging mode employed to process the image data.

9. The apparatus of claim 1, wherein the at least one processor is configured to:
determine, based on a power model of the apparatus, whether the imaging scheme is predicted to reduce power usage by the apparatus relative to a second imaging scheme of the plurality of imaging schemes; and
select the imaging scheme from the plurality of imaging schemes based also on whether the imaging scheme is predicted to reduce power usage by the apparatus relative to the second imaging scheme to select the imaging scheme.

10. The apparatus of claim 1, wherein the at least one processor is configured to:
select the imaging scheme from the plurality of imaging schemes based also on a transmission power of sending the image data to the companion device, wherein the transmission power is associated with a power model.

11. The apparatus of claim 1, wherein the at least one processor is configured to:
select the imaging scheme from the plurality of imaging schemes based also on an encoding power of encoding the image data before sending the image data to the companion device, wherein the encoding power is associated with a power model.

12. The apparatus of claim 1, wherein the at least one processor is configured to:
adjust a characteristic of a coupling based on the imaging scheme; and
send the image data to the companion device over the coupling to send the image data to the companion device.

13. The apparatus of claim 12, wherein the characteristic of the coupling includes a bit rate.

14. The apparatus of claim 1, wherein the at least one image processing operation includes image stabilization.

15. The apparatus of claim 1, wherein the denoising operation includes at least one of temporal denoising or spatial denoising.

16. The apparatus of claim 1, wherein the at least one image processing operation includes at least one of super-resolution or filtering.

17. The apparatus of claim 1, wherein the apparatus includes a head-mounted display (HMD) device, and wherein the companion device includes a portable computing device that is communicatively coupled to the apparatus using a communication interface.

18. The apparatus of claim 1, wherein the companion device is separate from the apparatus.

19. The apparatus of claim 18, wherein the apparatus is coupled to the companion device using a wireless communication interface.

20. A method of imaging, the method comprising:
selecting, based on at least a characteristic of power usage of an apparatus, an imaging scheme from a plurality of imaging schemes, wherein each of the plurality of imaging schemes represents a different division of image processing operations between the apparatus and a companion device;
sending image data to the companion device for processing the image data using at least one image processing operation to generate processed image data according to the imaging scheme, wherein the at least one image processing operation includes a denoising operation; and
receiving the processed image data from the companion device.
